(19) United States
(12) Patent Application Publication
(10) Pub. No.: US 2003/0190475 A1
(43) Pub. Date: Oct. 9, 2003

(54) Magnetic nanoparticles having passivated metallic cores

(76) Inventors: Everett Carpenter, Silver Spring, MD (US); Vincent Harris, Laurel, MD (US)

Correspondence Address: NAVAL RESEARCH LABORATORY, ASSOCIATE COUNSEL (PATENTS), CODE 1008.2, 4555 OVERLOOK AVENUE, S.W., WASHINGTON, DC, 20375-5320, US

(21) Appl. No.: 10/355,162

(22) Filed: Jan. 31, 2003

Related U.S. Application Data
(60) Provisional application No. 60/370,693, filed on Apr. 9, 2002.

(51) Int. Cl. B32B 5/16

(52) U.S. Cl. 428/403; 430/138; 428/900

(57) ABSTRACT

This invention discloses magnetic nanopaticles based on core/shell structures having passivated metal cores, and their method of synthesis. The passivated metallic core exhibits the favorable magnetic properties of iron, cobalt and other ferromagnetic metals, without their extreme oxygen sensitivity.

This patent application is based on provisional U.S. patent application serial No. 60/370,693 filed Apr. 9, 2002.

### FIELD OF INVENTION

This invention encompasses magnetic nanoparticles having shell/core structures and methods of sequential synthesis of said nanoparticles using reverse micelle synthesis.

### BACKGROUND OF THE INVENTION

Magnetic nanoparticles based on iron, cobalt, and nickel and their alloys have been synthesized in a variety of methods including sonochemical, photochemical, as well as other solution chemical methods. Composite nanoparticles with better magnetic properties using metallic iron or cobalt have not been synthesized to be air stable. Using the reverse micelle system it is possible to form a passivation layer that makes the metallic nanoparticles oxygen resistant. This passivation layer adds functionality to the particle. For high frequency applications the particles disrupt eddy currents that limit the frequency over which magnetic metals can be used. For biomedical applications this passivation layer acts as a template for surface functionalization. As a result, the metallic nanoparticles can be used in a variety of magnetic applications from biomedical to electromagnetic devices where their magnetic properties are most desirable.

### OBJECTS OF THE INVENTION

An object of this invention is to produce magnetic nanoparticles which are oxidation resistant and having a high magnetic moment;

Another objective of this invention is to produce magnetic nanoparticle which are capable of being functionalized without adversely effecting the magnetic properties;

Another objective of this invention is to produce magnetic nanoparticle which have tailored magnetic properties for specific applications;

Another objective of this invention is a process for making the oxidation resistant magnetic nanoparticles using surfactant assisted sequential synthesis.

### SUMMARY OF THE INVENTION

The magnetic nanoparticles of this invention are resistant to oxidation compared to the pyrophoric nature of other metallic nanoparticles of similar size. The material is in the form of a magnetic core of iron, cobalt, or nickel or their alloys, passivated with a shell composed of metal oxides including but not limited to Group 6 and/or Group 8 transition metals. Examples of metal oxides as shell materials are the oxides of chromium, molybdenum, tungsten, iron, cobalt or nickel or equivalents thereof. The metal magnetic nanoparticles are synthesized in a fashion which allows for the control of the core radius/shell thickness ratio. The process for making the nanoparticles involves the room temperature synthesis of the metal core using reverse micelles and other surfactant assisted methods followed in sequential steps the creation and partial oxidation of the shell material overlying the core.

### BREIF DESCRIPTION OF THE DRAWINGS

FIG. 1. shows a transmission electron micrograph of the core/shell magnetic nanoparticles with an average core diameter 6.07 nm, and with a shell width 2.7 nm giving a total particle diameter 11.47 nm.

FIG. 2. shows results of magnetization versus field experiments preformed on a Quantum Designs MPMS-5S magnetometer. The inset represents a plot of saturation versus time.

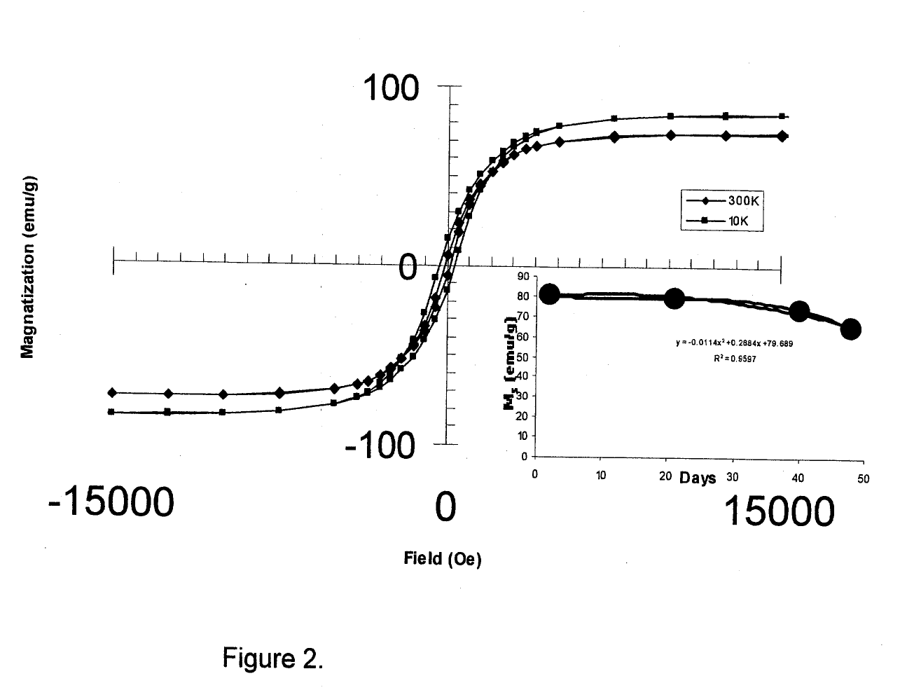

FIG. 3. shows the preferred synthesis sequence for making the core/shell materials of this invention.

FIG. 4. shows the E X-ray Absorption Fine Structure experiments compleyed at the X23B Beamline at the National Synchroton Light Source at Brookheaven National Laboratory. The metallic nature of the core is confirmed by comparison to experimental standards.

### DETAILED DESCRIPTION OF THE INVENTION

The product of this invention consists of a metallic core of one or more metals of Group 8 and at least one passivating metal oxide shell consisting of one or more transition metals of Group 6 and/or Group 8. The particle consists of a core/shell structure less than 100 nm in diameter with cores which are 5-90 nm in diameter and shell thickness is up to about 10 nm. The products of this invention include the following:

1. Passivated magnetic nanoparticles having a core/shell structure;

2. A sequential surfactant assisted process;

a. to create said core/shell nanoparticle with a controlled ratio of core to shell and allowing for functionalization without adversely affecting the magnetic properties;

b. allow for the final product form to be either powders or ferrofluids depending on the application;

c. tailoring of magnetic and electronic properties for a host of applications targeting electronic; computer and biomedical industries.

For the purpose of this invention, we define passivation to represent a substantially reduced reaction to oxidative conditions. Metal nanoparticles have an extreme reactivity to oxidation. In powder form the nanoparticle are pyrophoric resulting in spontaneous combustion when exposed to atmospheric oxygen. The passivated nanoparticles presented in this invention retain metallic properties for over six months as a free powder, with no appreciable degradation of magnetic properties for the first week.

The process for making the product presented in this invention involves the use of surfactants to control nucleation and growth of the particles. The surfactants used in this invention are from the class of cationic quaternary ammonium salts, nonionic polyoxyethoxylates and anionic sulfate esters. Specific surfactants include cetyltrimethylammonium bromide and nonylphenolpolyethoxylate 4 and 7 (NP-4 and NP-7). In a typical experiment, surfactant solution is prepared in a suitable hydrocarbon solvent such as cyclohexane, toluene, chloroform or other suitable organic solvent. The surfactant should be soluble. In the synthesis of the passivated core/shell magnetic nanoparticles four solutions are prepared. The four solutions include an aqueous metal salt solution for forming the core, an aqueous metal salt solution for forming the shell, an aqueous sodium borohydride solution, and an organic solvent surfactant solution. For reduction of the metal salts, reducing agents may be used, for example sodium borohydride and equivalents thereof.

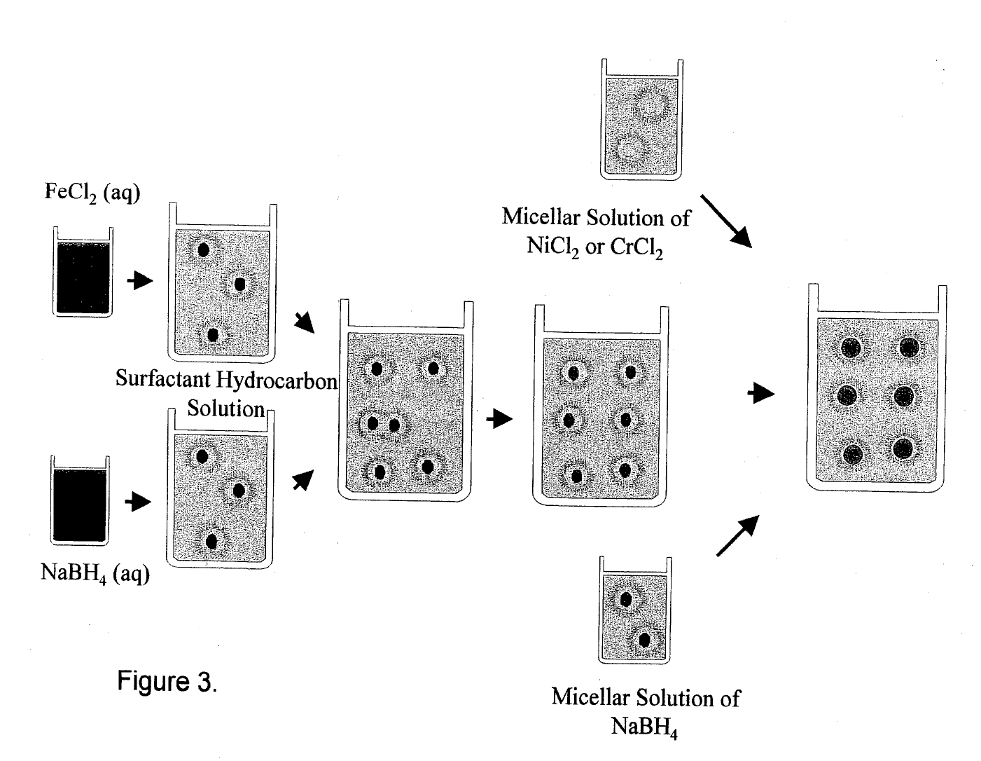

In practice, the metal salt solution which will form the core is mixed with the organic surfactant solution to form micelle solutions. The borohydride reducing solution is also mixed with organic surfactant solution to form micelle solutions. The two micelle solutions are then mixed and allowed to react. Following this the shell metal salt micelle and borohydride micelle solutions are added to the core micelle solution to form the core/shell passivated magnetic nanoparticles. The products of the reactions are then separated by magnetic separation. In this the reaction solution is diluted with alcohol in a separatory funnel and allowed to flow past a fixed rare-earth magnet. The magnetic particles are held in the funnel and separated from the mixture while unreacted precursors, oxidized products and surfactant are allowed to flow to waste. FIG. 3. demonstrates this preferred process.

In the synthesis, the micelle solution containing the reducing agent and metal salt are allowed to react for 45 minutes under flowing nitrogen. minutes. The micell solution is diluted with the addition of aqueous shell-reactant solution. The shell is allowed to react for five minutes using the metal core as a nucleation source to form the shell material

Although the method described above features a reverse micelle process, the technique can be modified to allow for non-aqueous reductive elimination of organometallic precursors such as iron 2,4-pentadionate or iron carbonyl being dissolved in the surfactant solution directly and then when aqueous borohydride is added, the metal core is formed.

### EXAMPLE 1

This example demonstrates preparation of chromium iron oxide coated iron nanoparticles where the core diameter is up to about 50 nm with a shell of about 2 nm.

219 mg iron (II) chloride dissolved in 1.6 ml deionized water was used as the aqueous core precursor. 191 mg sodium borohydride was dissolved in 1.5 ml of deionized water for use as the reducing agent. The surfactant solution was prepared using 28.0 grams cetyltrimethylammonium bromide (CTAB) dissolved in 200 ml of chloroform. The aqueous metal solution was mixed with 50 ml CTBA solution and placed in a flask under flowing nitrogen. The sodium borohydride solution was mixed with 50 ml of the CTAB solution and sonicated for four minutes to degas and homogenize. The sodium borohydride/CTAB solution was added to the iron chloride/CTAB solution and allowed to react with magnetic stirring under flowing nitrogen for 45 minutes.

The shell precursor was prepared using 210 mg of chromium (II) chloride mixed with 1.8 ml deionized water. The solution was sonicated for one minute and centrifuged at 5000 rpm for five minutes. The solution was decanted into 50 ml CTAB solution and sonicated for 10 minutes. Additional 150 mg of sodium borohydride was dissolved in 1.8 ml of deionized water and added to 50 ml CTAB solution. The micelle metal solution for forming the shell was injected into the reaction vessel containing the core material as described in the immediately preceding paragraph. The reaction was allowed to react for five minutes.

The reaction solution was quenched by adding a large excess of chloroform/methanol solution. The quenched solution was placed in a separatory funnel to allow for magnetic separation of the final product from the surfactant and paramagnetic side products.

### EXAMPLE 2

This example demonstrates preparation of nickel ferrite coated iron nanoparticles where the core diameter is an average of six nm and the shell has a thickness of about two nm. The surfactant solution was prepared using 30.0 grams of nonylphenol polyethoxylate 7 (NP-4) and 10.0 gram of nonylphenol polyethoxylate 4 (NP-4) dissolved in 200 ml toluene. 190 mg iron (II) pentadionate was dissolved in 50 ml of the NP-4, NP-7 solution in toluene.

191 mg sodium borohydride was dissolved in 1.5 ml deionized water as the reducing agent. The borohydride solution was mixed with 50 ml of the surfactant solution and sonicated for four minutes to degas and homogenize. The sodium borohydride/surfactant solution was then added to the iron/surfactant solution and allowed to react under flowing nitrogen with magnetic stirring for 45 minutes.

The shell precursor was prepared using 210 mg nickel (II) 2,4-pentadianote mixed with 50 ml of the NP-4 and NP-7/toluene solution. The solution was sonicated for one minute and centrifuged at 5000 rpm for five minutes. The solution was decanted and set aside. Additional 250 mg sodium borohydride was dissolved in 1.8 ml deionized water and added to 50 ml of the NP-4, NP-7 solution. The shell reaction mixture was then injected into the core reaction mixture, followed by the borohydride solution. The total reaction was allowed to react for five minutes.

The reaction mixture was quenched by adding a large excess of chloroform/methanol solution. The quenched solution was placed in a separatory funnel to allow for magnetic separation of the final shell/core magnetic nanoparticle composition from the surfactant and paramagnetic side products.

Properties of the Magnetic Nanoparticles

The magnetic properties of the nanoparticles of this invention were measured using a Quantum Design MPMS-5S SQUID magnetometer over a temperature range of 10K-300K.(FIG. 3.) The goal is to maximize magnetic moment per unit volume. Our first successful trial has a 45 nm (measure by dynamic light scattering) iron core passivated by a thin chromium oxide shell. The measured magnetic moment was 140 emu/gram (room temperature) compared with 220 emu/gram foe metallic iron. A MnZn-ferrite particle of similar size would be 27% lower in magnetization, and a NiZn-ferrite particle of similar size would be 82% reduced. These are two leading ferrite materials. This illustrates success our goal of increasing the magnetic moment of a particle with an insulating passivated shell.

The magnetic particles of this invention are designed to have ferromagnetic metallic cores and a passivating insulating shell. One reason for this is that metals having a high moment are not used for high frequency applications since eddy currents form in the metal and limit their frequency range to kHz. As a result magnetic oxides like spinel ferrites are the only magnetic materials suitable for high frequency applications. The drawback to their use is low magnetization. Composite nanoparticles of this invention offer suitable alternatives to the spinels in that they provide higher magnetization and the benefit of disrupting eddy currents.

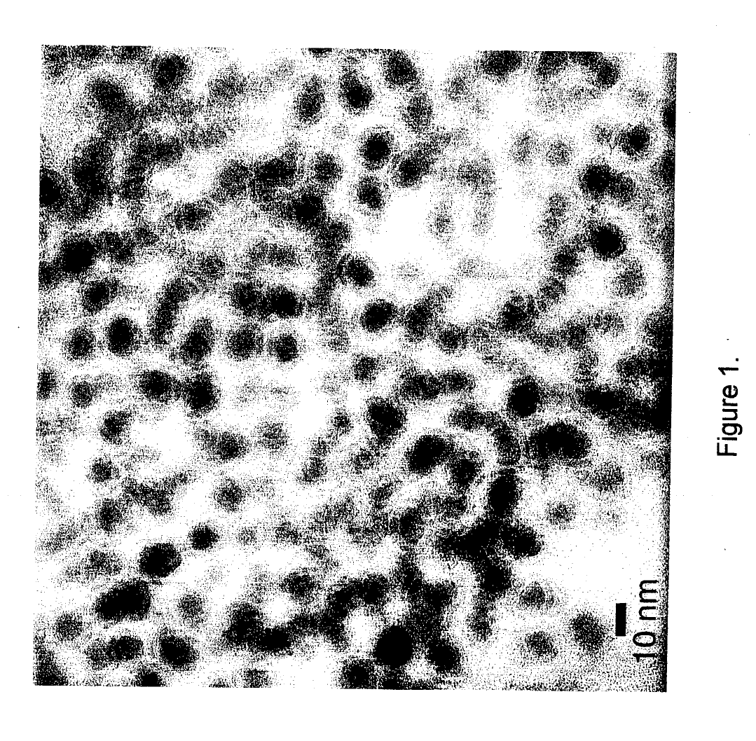

FIG. 1. shows a transmission electron micrograph of core/shell nanoparticles with an average core diameter of 6.07 nm and with a shell thickness of 2.7 nm giving a total particle diameter of 11.47 nm.

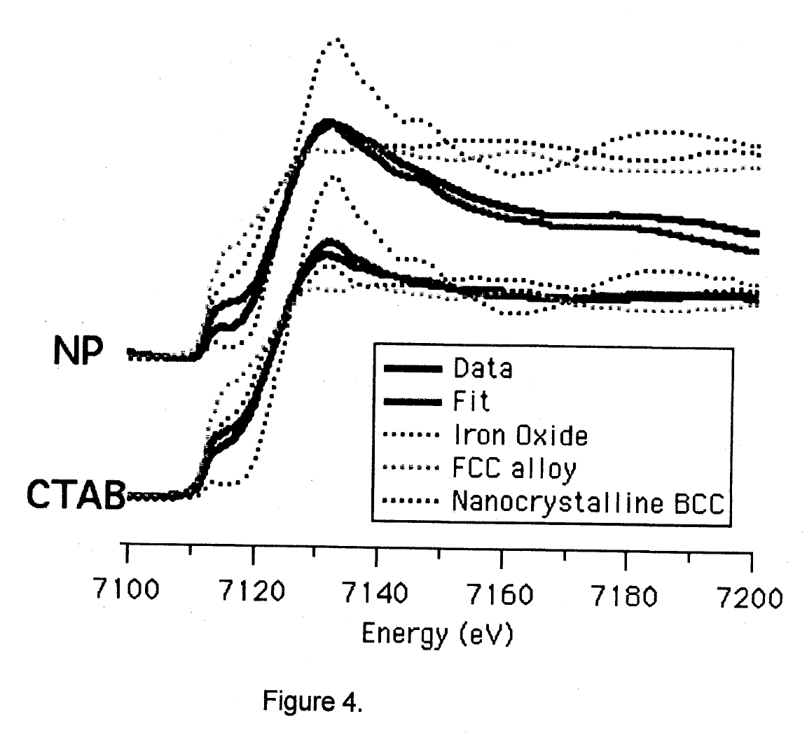

FIG. 4. shows a plot of the Extended X-ray absorption Fine Structure data collected by XIIA beamline at the National Synchrotron Light Source at Brookhaven National Laboratory. This data was normalized to the edge jump and compared to experimental standards. The results support a nanoparticle composed of 50-75% metallic iron core.

What is claimed is:

1. A composition of matter: said composition comprising; magnetic nanoparticle compositions having shell/core structures.

2. The composition of claim 1.; wherein said magnetic nanoparticles have a diameter range of up to about 100 nm.

3. The composition of claim 1.; wherein said shell has a thickness of up to about 10 nm.

4. The composition of claim 1.; wherein said magnetic nanoparticles are passivated magnetic nanoparticles.

5. The composition according to claim 1.; where said core is selected from the group consisting of; iron, cobalt, nickel, or alloys thereof or equivalents thereof.

6. The composition of claim 1.; wherein said shell is selected from the group consisting of: group 6 or group 8 transition metal oxides.

7. The composition of claim 6.; wherein said metal oxides are selected from the group consisting of: the oxides of chromium, molybdenum, tungsten, iron, cobalt, or nickel or equivalents thereof.

8. A composition of matter: said composition comprising; passivated magnetic nanoparticles having a shell and core structure with a diameter of up to about 100 nm, and a shell thickness of up to about 10 nm.

9. A composition of matter according to claim 8.; wherein said core is iron and said shell is selected from the group consisting of: the oxides of chromium, molybdenum, tungsten, iron, cobalt, or nickel or equivalents therof.

10. A method of making passivated shell/core magnetic nanoparticle compositions; comprising the steps of:
(1) making compositions comprising:
(a) aqueous metal salt solutions for making said core;
(b) aqueous metal salt solutions for making said shell;
(c) aqueous sodium borohydride solutions for reducing said metal salts in solutions (a) and (b);
(d) surfactants dissolved in organic solvents;
(2) making said core by mixing solutions (a), (c), and (d) above;
(3) making said shell by mixing solutions (b), (c), and (d) above;
(4) making said shell/core composition by mixing (2) and (3) above and passivating said product thereof by exposure to an oxidizing medium.

11. The method of claim 10; wherein said core metal is selected from the group consisting of iron, cobalt, or nickel, or alloys thereof or equivalents thereof.

12. The method of claim 10, wherein said shell is selected from the group consisting of; group 6 or group 8 transition metal oxides.

13. The method of claim 10; wherein said metal oxides are selected from the group consisting of: the oxides of chromium, molybdenum, tungsten, iron cobalt, or nickrl or equivalents thereof.

14. The method of claim 10; wherein said passivated nanoparticle composition has a diameter of up to about 50 nm.

15. The method of claim 10; wherein said shell has a diameter of up to about 10 nm.

16. The method of claim 10; wherein said surfactants are selected from the group consisting of: trialkylammonium salts, nonylphenolpolyethoxylates, sodium dodecylbenzenesulfonates, or bis (2-ethylhexyl)sulfosuccinate ester.

17. The method of claim 16, wherein said surfactant is selected from the group consisting of: cetyltrimethylammonium bromide or nonylphenolpolyethoxylate 4 or 7.
